(19) United States
(12) Patent Application Publication
(10) Pub. No.: US 2008/0118660 A1
(43) Pub. Date: May 22, 2008

(54) METHOD OF FABRICATING WIRE GRID POLARIZER

(75) Inventors: Yoon-sun CHOI, Incheon-si (KR); Jae-young CHOI, Suwon-si (KR); Moon-gyu LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/847,404

(22) Filed: Aug. 30, 2007

(30) Foreign Application Priority Data
Nov. 21, 2006 (KR) 10-2006-0115423

(51) Int. Cl. B05D 5/06; B05D 3/06

(52) U.S. Cl. 427/532; 427/163.1

(57) ABSTRACT

Provided is a method of fabricating a wire grid polarizer, including: forming a photoresist having a striped pattern on a substrate, wherein a plurality of grooves are periodically formed in the photoresist; and forming a wire grid by filling a solution including dispersed nano metal particles in the grooves and then by removing a solvent of the solution to form the wire grids.

### CROSS-REFERENCE TO RELATED PATENT APPLICATION

This application claims the benefit of Korean Patent Application No. 10-2006-0115423, filed on Nov. 21, 2006, in the Korean Intellectual Property Office, the disclosure of which is incorporated herein in its entirety by reference.

### BACKGROUND OF THE INVENTION

1. Field of the Invention

The present invention relates to a method of fabricating a wire grid polarizer, and more particularly, to a method including an improved process of forming a wire grid to fabricate a large area wire grid polarizer.

2. Description of the Related Art

Wire grid polarizers have wire grid structures in which metal wires protruding in stripe shapes on transparent substrates are arranged at fixed intervals. If the arrangement intervals of the metal wires are greater than a wavelength of electromagnetic waves, a general diffraction phenomenon occurs. Also, if the arrangement intervals are smaller than the wavelength of the electromagnetic waves, a specific polarization phenomenon occurs. In other words, if the arrangement intervals of the metal wires, i.e., intervals of the lattices, are small, light polarized parallel to the metal wires, i.e., S polarized light, is reflected, while light polarized perpendicular to the metal wires, i.e., P polarized light, is transmitted therethrough. The width, thickness, and arrangement intervals of the metal wires are related to polarization characteristics of the wire grid polarizers, i.e., transmission ratio and reflectivity.

In general, a wire grid polarizer is required to have an interval of 200 nm and a line width structure of 100 nm or less in order to be used for visible rays in a band between 400 nm and 700 nm. However, it is difficult to fabricate a wire grid having a micro-pattern with a line width of 100 nm using a conventional lithography process. Thus, to fabricate a conventional wire grid polarizer, a master pattern is formed using an electron beam (E-beam), and then a mold is fabricated as a reverse image of the master pattern. Next, a metal and polymer are stacked on a transparent substrate, and a pattern is formed on the polymer using the mold. Then, the metal is etched according to the pattern to complete the wire grid polarizer. However, a method of fabricating a conventional wire grid polarizer is complicated, not appropriate for mass-production, and requires expensive equipment. Furthermore, a size of a wire grid polarizer fabricated using the method is several inches and thus the wire grid polarized may not be suitable for use in a liquid crystal display (LCD) panel having a large area of tens of inches or more.

### SUMMARY OF THE INVENTION

The present invention provides a method of fabricating a wire grid polarizer by which nano-sized wire grids having micro-intervals can be formed to have a large-sized area using a dipping process.

According to an aspect of the present invention, there is provided a method of fabricating a wire grid polarizer, including: forming a photoresist having a stripe pattern on a substrate, wherein a plurality of grooves are periodically formed in the photoresist; and forming a wire grid by filling a solution including a solvent and metal particles dispersed in the solvent, in the grooves and by removing the solvent.

In embodiments of the invention, the forming of the photoresist having the striped pattern comprises: coating the photoresist on the substrate; light having a striped pattern onto the photoresist; developing the photoresist.

In embodiments of the invention, the forming of the wire grid comprises: dipping the substrate into the solution; and heating the substrate to remove the solvent.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic perspective view of a wire grid polarizer according to an embodiment of the present invention;

FIGS. 2 through 4 are cross-sectional views illustrating a process of forming a photoresist having a striped pattern on a substrate according to an embodiment of the present invention;

FIGS. 5 through 9 are cross-sectional views illustrating a process of forming a metal grid on a substrate according to an embodiment of the present invention; and

FIGS. 10 and 11 are cross-sectional views illustrating a process of forming a passivation layer on a substrate on which a metal grid is formed, according to an embodiment of the present invention.

### DETAILED DESCRIPTION OF THE INVENTION

Hereinafter, a method of fabricating a wire grid polarizer according to an embodiment of the present invention will be described in detail with reference to the attached drawings.

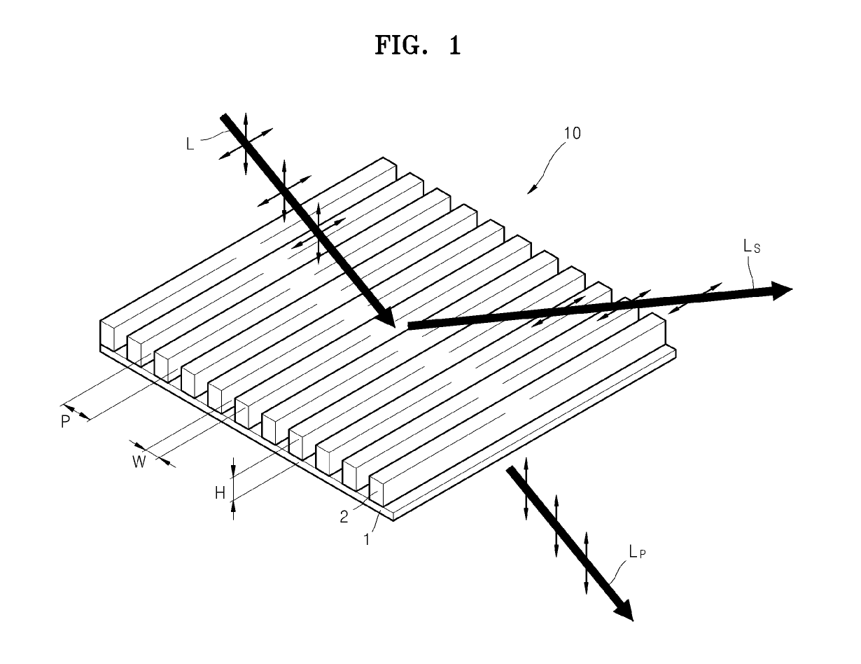

FIG. 1 is a schematic perspective view of a wire grid polarizer 10 according to an embodiment of the present invention. Referring to FIG. 1, the wire grid polarizer 10 includes a transparent substrate 1 and a plurality of metal wire 2. Metal wires 2 are regularly arranged each parallel to another at an interval to form a wire grid of a stripped pattern. A height H, a width W, and a period P of the wire grids 2 may vary depending on an optical design.

In general, diffracting gratings have a greater period than a wavelength of light. Light passing the diffracting gratings are split into a plurality of diffracted light beams. If the period of the diffracting gratings is less than or equal to half of a wavelength of incident light L, the incident light L is split into a reflected light of S polarization Ls and a transmitted light of P polarization Lp, which corresponds to 0^{th}-order diffracted light, rather than splitting into a plurality of diffracted light beams.

Polarization characteristics of the wire grid polarizer 10 may be expressed by a polarization extinction ratio and a transmission ratio. The polarization extinction ratio indicates a ratio of an intensity of polarized light of transmitted light, which is perpendicular to a wire grid, to an intensity of polarized light, which is horizontal to the wire grid. The transmission ratio indicates a ratio of an intensity of incident light to an intensity of transmitted light, i.e., an intensity of light perpendicular to the wire grid. It is required for the metal wires 2 to be arranged at an interval, which is smaller than a wavelength of incident light, in order to have a high polarization extinction ratio and transmission ratio. In the wire grid polarizer 10 according to the present embodiment, a width W of a metal wire may be within a range of 50 nm and 100 nm, a height H of the metal wire may be within a range between 100 nm and 200 nm, and a grid period P may be within a range between 100 nm and 150 nm. Thus, the wire grid polarizer 10 may have high polarization extinction ratio and transmission ratio with respect to visible rays having a wavelength between 400 nm and 700 nm

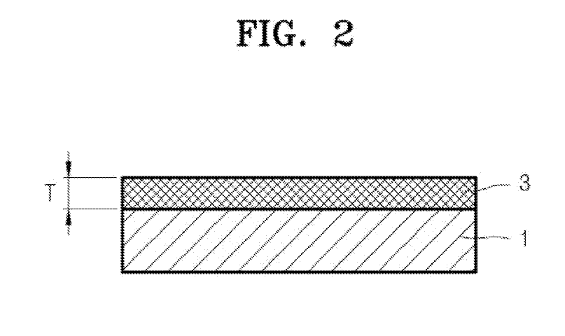

A method of fabricating a wire grid polarizer according to an embodiment of the present invention will now be described with reference to FIGS. 2 through 11.

Referring to FIG. 2, a photoresist 3 for forming patterns is formed to a predetermined thickness T on a substrate 1. The substrate 1 is formed of a transparent material. The thickness T of the photoresist 3 must be equal to or larger than a height H (as shown in FIG. 1) of a metal wire which will be formed in a subsequent process. The thickness T of the photoresist 3 may be within a range between 100 nm and 200 nm.

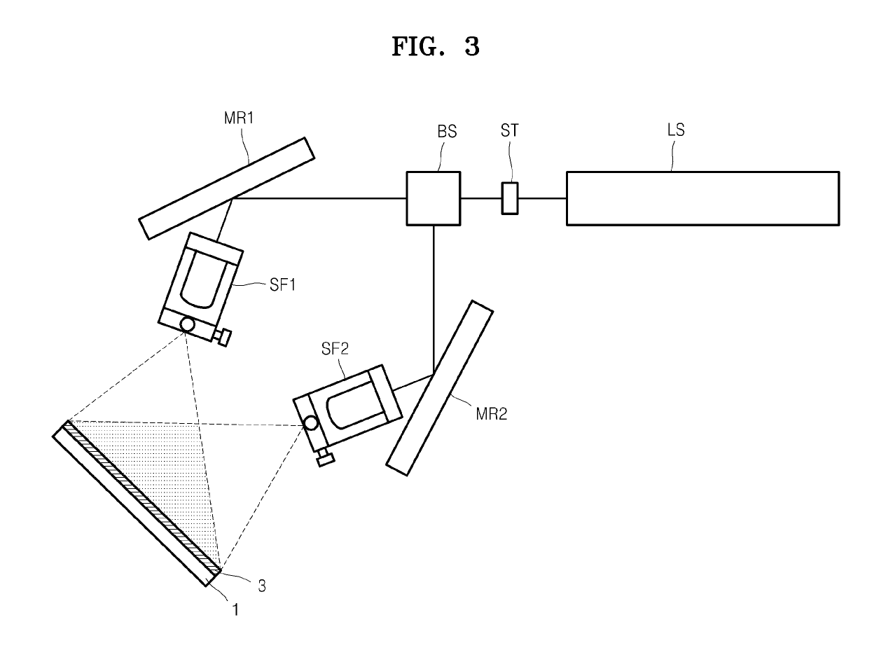

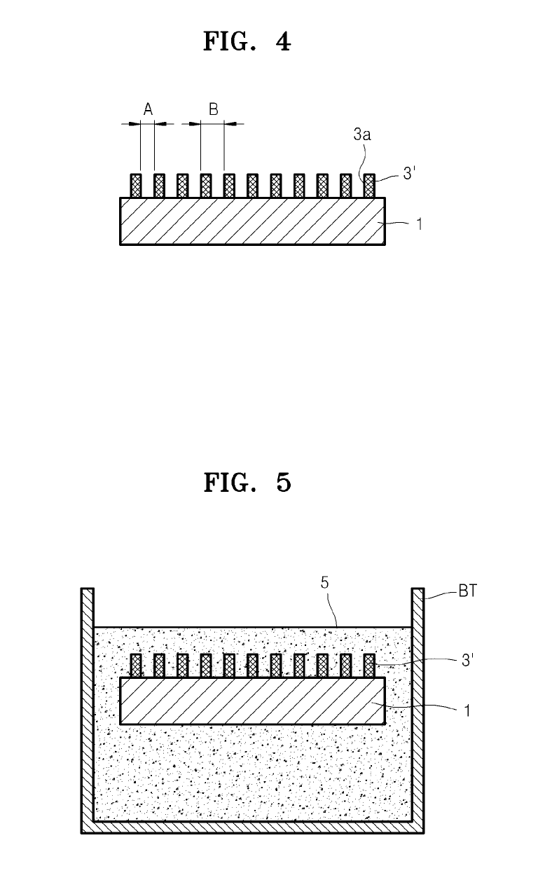

Referring to FIG. 3, light having a striped pattern is irradiated onto the photoresist 3. The striped pattern is a complementary pattern for a wire grid which will be formed in a subsequent process. The striped pattern may have a width A of FIG. 4 between 50 nm and 100 nm and a period B of FIG. 4 between 100 nm and 150 nm so as to be suitable in a visible ray band.

Referring to FIG. 3, using laser interference lithography, a laser beam irradiated from a laser LS is split into two laser beams using a beam splitter (BS) and the two laser beams are irradiated onto the substrate 1 at different angles through mirrors MR1 and MR2. The two laser beams irradiated at different angles are modulated to form desired interference patterns through spatial filters SF1 and SF2. If the laser beam is an ultraviolet ray or a deep ultraviolet ray, interference patterns each having a size from tens nm to hundreds nm may be formed. Laser interference lithography is performed to form striped patterns having a regular or uniform interval to a large-scaled size and thus suitable for fabricating a wire grid polarizer. However, in the present invention, a process of forming the striped pattern on the photoresist 3 is not limited to such a laser interference lithography method but may be formed using an electron beam (E-beam) lithography method for forming striped patterns having a size of tens nm, a nano-imprint lithography method, etc. In FIG. 3, ST denotes a shutter which controls the irradiation of the laser LS.

Referring to FIG. 4, the photoresist 3 onto which light having a striped pattern has been irradiated may be developed to form a photoresist 3′ having a striped pattern, wherein a plurality of grooves 3a are periodically formed in the photoresist 3′. The grooves 3a having a striped pattern are developed to expose the substrate 1. After the photoresist 3′ having the striped pattern is formed, a surface of an upper end of the photoresist 3′ may be modified to prevent a metal wire from being tangled in a process of forming a wire grid as will be described later.

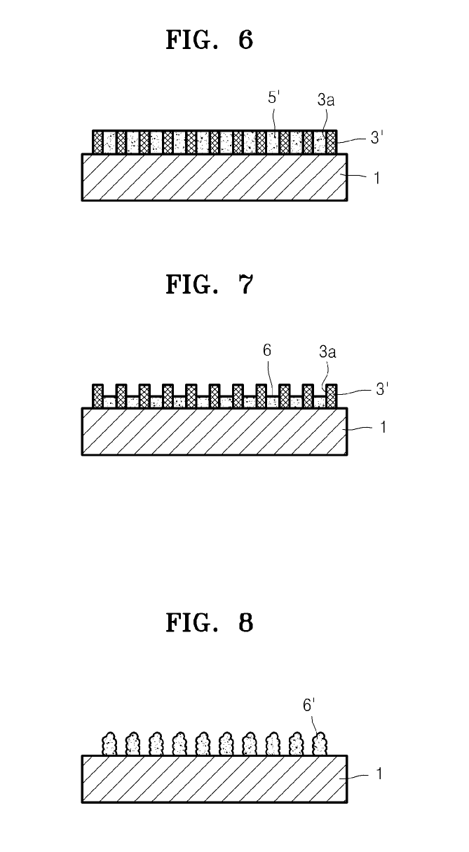

Referring to FIGS. 5 and 6, a dipping process is performed to dip the substrate 1 with the patterned photoresist 3′ into a bath BT including a solution 5 having nano metal particles dispersed therein. When the solution 5 is sufficiently soaked into the grooves 3a, the substrate 1 is taken out of the bath BT. Thus obtained substrate 1 has a patterned photoresist 3′ and a nano metal particle-containing solution 5′ saturated in the grooves 3a.

The nano metal particles dispersed in the solution 5 may be formed of a highly conductive material, for example, Ag, Al, Au, Cu, Fe, Ni, Ti, T, Cr, or an alloy of Ag, Al, Au, Cu, Fe, Ni, Ti, T, and Cr. A size of the nano metal particles may be within a range between 5 nm and 50 nm, more preferably, within a range between 5 nm and 10 nm.

The solution 5 containing the nano metal particles may be an aqueous solution or an organic solution. The organic solution may include, but is not limited to, an aliphatic hydrocarbon solvent such as hexane or heptane, an aromatic hydrocarbon solvent such as anisol, mesitylene, or xylene, a ketone-based solvent such as methyl isobutyl ketone, 1-methyl-2-pyrrolidinone, or acetone, an ether-based solvent such as cyclohexanone, tetrahydrofuran, or isopropyl ether, an acetate-based solvent such as ethyl acetate, butyl acetate, or propylene glycol methyl ether acetate, an alcohol-based solvent such as isopropyl alcohol or butyl alcohol, an amide-based solvent such as dimethylacetamide or dimethylformamide, or a silicon-based solvent, or mixtures thereof.

A solution removal process for removing a solution is performed using a heating method or the like so that only a metal particle lump 6 remains in the grooves 3a on the substrate 1 as shown in FIG. 7.

A height of the metal particle lump 6 left in the grooves 3a after the solution is removed may be about 1/10 of a height of the nano metal particles-containing solution 5′ filled in the grooves 3a (as shown in FIG. 5). Thus, the dipping process and the solution removal process may be repeated to obtain a desired height of a metal wire. If the dipping process and the solution removal process are repeated, the nano metal particles may be coagulated on the photoresist 3′, and thus the metal wires may be connected to one another. After the photoresist 3′ is developed, the surface of the upper end of the photoresist 3′ may be modified as described with reference to FIG. 4, so as to prevent the metal wires from being connected to one another.

For example, the surface of the patterned photoresist 3′ may be treated to have an oleophilic property and dipped into an aqueous solution of metal particles. In other words, the substrate 1 is coated with a polymer of an oleophilic or lipophilic property (e.g., a fluorine-based polymer having an oleophilic property) and then imprint the coating on the surface of the patterned photoresist 3′ to transfer the fluorine-based polymer from the surface of the substrate 1 to the surface of the patterned photoresist 3′ so that the surface of the photoresist 3′ exhibits an oleophilic property. Thus, an upper part of the patterned photoresist 3′, which is oleophilic, repels the aqueous solution of the nano metal particles, while the grooves 3a of the photoresist 3′ are soaked with the aqueous solution of the metal particles. Thus, the nano metal particles are not coagulated in the upper part of the photoresist 3′ and, thus, the metal wires can be prevented from being connected to one another.

Alternatively, the surface of the patterned photoresist 3′ may be treated to become hydrophilic and then dipped into an oleophilic or lipophilic solution of metal particles. For example, an acrylic polymer having a hydrophilic property may be coated on a substrate and then imprinted on the surface of the photoresist 3′ to transfer the acrylic polymer to the upper surface of the photoresist 3′ so that the surface of the photoresist 3′ exhibits a hydrophilic property. In this case, the oleophilic or lipophilic solution of metal particles is not soaked into the upper part of the photoresist 3′. Thus, the nano metal particles are not coagulated in the upper part of the photoresist 3′ and, thus, the subsequently resulting metal wires are prevented from being connected to one another.

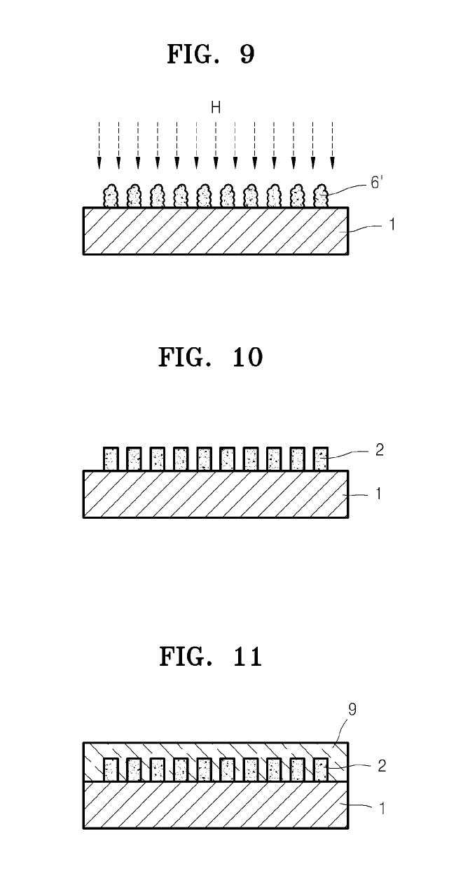

As shown in FIG. 8, the photoresist 3′ is removed so that only metal particle lumps 6′ each having a desired height remain on the substrate 1. The metal particle lumps 6′ may have a low density and be easily broken and thus may be sintered through heating or the like as shown in FIG. 9. The substrate 1 is put into a heating furnace or a laser or infrared rays is irradiated onto the substrate 1 to heat the substrate 1 at a temperature between 150° C. and 250° C., preferably, at a temperature of 200° C.

FIGS. 10 and 11 are cross-sectional views of a wire grid polarizer including metal wires 2 formed using a sintering process. Referring to FIGS. 10 and 11, the metal wires 2 form a fine pattern and thus may easily be damaged. Thus, passivation layer 9 may be coated on the grid of metal wires 2 to protect the grid 2. The passivation layer 9 has a lower refraction index than the metal wires 2 to correctly operate the wire grid polarizer.

The above-described method of fabricating the wire grid polarizer is simple, suitable for mass-production, and does not require expensive equipment. A wire grid polarizer fabricated using the above-described method can have a large-sized area and be easily applied to an LCD panel having a large-sized area of tens of inches or more. When a wire grid polarizer of the present invention is applied to a large-sized LCD panel as described above, the wire grid polarizer can have improved characteristics compared to an absorption type polarizer which uses a double refraction material or the like. The absorption type polarizer transmits only 50% of light, and absorbs the remaining 50% of the light. Thus, the light is lost. Also, when the absorption type polarizer is exposed to a high luminance light source, a dielectric material may be thermally deformed. The absorption type polarizer is unstable. However, the wire grid polarizer reflects S-polarized light, and transmits P-polarized light. Thus, if the reflected S-polarized light is reused, the use efficiency can almost reach 100%. Furthermore, the wire grid polarizer can have a structure in which wire grids are formed of a metal material on a transparent substrate. Thus, even when the wire grid polarizer is exposed to the high luminance light source, the wire grid polarizer is thermally stable.

As described above, in a method of fabricating a wire grid polarizer according to the present invention, wire grids can be formed using a dipping process. Thus, the method can be simple and suitable for mass-production and does not require expensive equipment. Also, the wire grid polarizer can be fabricated to have a large-sized area.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of fabricating a wire grid polarizer, comprising:
forming a photoresist having a striped pattern on a substrate, wherein a plurality of grooves are periodically formed in the photoresist; and
forming a wire grid by filling a solution comprising a solvent and metal particles dispersed in the solvent, in the grooves and by removing the solvent.

2. The method of claim 1, wherein the forming of the photoresist having the striped pattern comprises:
coating the photoresist on the substrate;
irradiating light having a striped pattern onto the photoresist;
developing the photoresist.

3. The method of claim 2, wherein a thickness of the photoresist coated on the substrate is between 100 nm and 200 nm.

4. The method of claim 2, wherein the irradiating of light is carried out by a laser interference lithography method, an E-beam (electron-beam) lithography method, or a nano-imprint lithography method.

5. The method of claim 2, which further comprises modifying a surface of an upper end of the photoresist.

6. The method of claim 1, wherein the photoresist having the striped pattern is formed so that the striped pattern has a width between 50 nm and 100 nm.

7. The method of claim 1, wherein the photoresist having the striped pattern is formed so that the striped pattern has a period between 100 nm and 150 nm.

8. The method of claim 1, wherein the forming of the wire grid comprises:
dipping the substrate into the solution; and
heating the substrate to remove the solvent.

9. The method of claim 8, wherein the dipping process and the solvent removal process are repeated at least one more time to form the wire grid to a desired height.

10. The method of claim 9, wherein the height of the wire grid is between 100 nm and 200 nm.

11. The method of claim 1, further comprising sintering the wire grids.

12. The method of claim 11, wherein the wire grid are sintered at a temperature between 150° C. and 250° C.

13. The method of claim 1, further comprising providing a passivation layer on the wire grids.

14. The method of claim 1, wherein the metal particles have a size between 5 nm and 50 nm.

15. The method of claim 14, wherein the metal particles are formed of one of at least one of Ag, Al, Au, Cu, Fe, Ni, Ti, T, Cr, and their alloys.

16. The method of claim 1, wherein the solvent is water or an organic solvent.

17. The method of claim 16, wherein the organic solvent is one selected from the group consisting of an aliphatic hydrocarbon solvent, an aromatic hydrocarbon solvent, a ketone-based solvent, an ether-based solvent, an acetate-based solvent, an alcohol-based solvent, an amide-based solvent, a silicon-based solvent, and mixtures thereof.
